(19) United States
(12) Patent Application Publication
(10) Pub. No.: US 2012/0074264 A1
(43) Pub. Date: Mar. 29, 2012

(54) AIRPLANE WING

(76) Inventor: Clifford D. Heaton, Ware, MA (US)

(21) Appl. No.: 13/240,293

(22) Filed: Sep. 22, 2011

Related U.S. Application Data
(60) Provisional application No. 61/385,987, filed on Sep. 24, 2010.
(60) Provisional application No. 61/510,678, filed on Jul. 22, 2011.

(51) Int. Cl. B64C 39/12; B64C 3/48; B23P 11/00; B64C 3/50

(52) U.S. Cl. 244/213; 244/45 R; 244/201; 29/428

(57) ABSTRACT

An airplane wing configuration includes a first wing positioned above and forward of a second wing on an airplane fuselage. The first wing is operable to direct airflow over an upper surface of the second wing, whereby the first and second wings are capable of generating greater lift than a sum of their individual lifts. The first wing may include an adjustable wing flap that redirects airflow over the upper surface of the second wing, and the second wing may include a rotatable portion that pivots to vary the angle of attack of the second wing independent of the first wing.

### CROSS-REFERENCE TO RELATED APPLICATIONS

This application claims the priority of U.S. Provisional Application No. 61/385,987 filed Sep. 24, 2010 and U.S. Provisional Application No. 61/510,678 filed Jul. 22, 2011.

### TECHNICAL FIELD

This invention relates to airplane wings, and more particularly to a dual wing configuration.

### BACKGROUND OF THE INVENTION

It is known in the art relating to aircraft that modern, conventional airplanes typically are monoplanes that include one wing on each side of the fuselage. Another conventional wing configuration is a biplane in which the aircraft includes two wings stacked one on top of the other. While a biplane can produce more lift than a similarly sized monoplane of similar wingspan, the biplane produces more drag. Therefore, monoplanes have commonly been favored over biplanes.

It is also known that conventional airplanes require a certain minimum air speed during landing in order to maintain lift. However, these conventional landing air speeds are by nature more dangerous than lower air speeds. Also, the higher the landing air speed, the greater the wear on the airplanes tires due to increased friction on landing.

### SUMMARY OF THE INVENTION

The present invention provides an improved airplane wing configuration including a dual wing arrangement. The present airplane wing configuration allows for substantially reduced landing speeds, making air travel safer, and thus for the use of shorter runways. The configuration greatly expands the airspeed envelope in which an airplane equipped with the present wing configuration is able to operate over previous wing configurations, and still allows the aircraft to maintain acceptable/comparable cruise efficiency and general fuel efficiency during normal operations.

More particularly, an airplane wing configuration in accordance with the present invention includes a first wing positioned above and forward of a second wing on an airplane fuselage. The first wing is operable to direct airflow over an upper surface of the second wing, whereby the first and second wings are capable of generating greater lift than a sum of their individual lifts. Specifically, the first wing may include an adjustable wing flap that redirects airflow over the upper surface of the second wing, and the second wing may include a rotatable portion that pivots to vary the angle of attack of the second wing independent of the first wing.

In one embodiment, an airplane wing configuration in accordance with the present invention includes a first wing having a wing root fastened to an airplane fuselage and an opposite wing tip. The wing configuration also includes a second wing having a wing root fastened to the airplane fuselage and an opposite wing tip. The second wing is disposed on a same side of the airplane fuselage as the first wing, and the first wing is positioned above and forward of the second wing. The wing tip of the first wing is joined to the wing tip of the second wing. The second wing is operable to change its angle of attack independent of the first wing.

The first wing may include a wing flap that redirects airflow over an upper surface of the second wing. The second wing may include a rotatable portion between the wing root and the wing tip. The rotatable portion of the second wing may be rotatable in a range of at least 45 degrees, and even more in a range of at least 140 degrees. The first wing may be swept back, and the first and second wings may have a high aspect ratio.

In another embodiment, an airplane wing configuration in accordance with the present invention includes a first wing fastened to an airplane fuselage, and a second wing including a wing root fastened to the airplane fuselage and an opposite wing tip. The first wing is positioned above and forward of the second wing, and the second wing is operable to change its angle of attack independent of the first wing.

The first wing may include a wing flap that redirects airflow over an upper surface of the second wing. The second wing may include a rotatable portion between the wing root and the wing tip.

A method of configuring two airplane wings to act in concert with each other includes the steps of: fastening a first wing to an airplane fuselage, the first wing including a wing flap disposed at a trailing edge thereof; fastening a second wing to the airplane fuselage, the first wing being positioned above and forward of the second wing, and the second wing being operable to change its angle of attack independent of the first wing; adjusting the wing flap of the first wing to direct airflow from the first wing over an upper surface of the second wing; and rotating at least a portion of the second wing to increase the angle of attack of the second wing.

The wing flap of the first wing may be adjusted into a retracted position, and the angle of attack of the second wing may be adjusted so that it is generally equal to the angle of attack of the first wing, whereby the first and second wings are disposed in a cruise flight orientation. The wing flap of the first wing may be partially lowered while maintaining the angle of attack of the second wing, whereby the first and second wings are disposed in an altitude decent orientation. The wing flap of the first wing may be partially lowered, and the disposition of the second wing may be adjusted by rotating the portion of the second wing to increase the angle of attack of the second wing, whereby the first and second wings are disposed in a landing approach orientation. The angle of attack of the second wing may be further increased by rotating the portion of the second wing, whereby the first and second wings are disposed in a final approach orientation. The wing flap of the first wing may be fully lowered, and the disposition of the second wing may be adjusted by rotating the portion of the second wing so that the second wing is generally parallel with the wing flap of the first wing, whereby the first and second wings are disposed in a short takeoff or touchdown orientation. The disposition of the second wing may be adjusted by rotating the portion of the second wing so that the portion of the second wing is oriented more than 90 degrees from horizontal, whereby the first and second wings are disposed in an air brake orientation. The disposition of the second wing may be adjusted by rotating the portion of the second wing so that the portion of the second wing is in a generally vertical orientation.

These and other features and advantages of the invention will be more fully understood from the following detailed description of the invention taken together with the accompanying drawings.

### BRIEF DESCRIPTION OF THE DRAWINGS

In the drawings:

FIG. 1 is a plan view of an airplane having an airplane wing configuration including an upper wing and a lower wing in accordance with the present invention;

FIG. 2 is an enlarged, partial view of the airplane wing configuration of FIG. 1 illustrating movement of the upper and lower wings;

FIG. 3 is a side, sectional view of the airplane wing configuration taken along the line I-I in FIG. 1 schematically illustrating several orientations of the upper and lower wings;

FIG. 4 is an enlarged side, sectional view of the airplane wing configuration taken along the line I-I in FIG. 1 schematically illustrating several orientations of the upper and lower wings;

FIG. 5 is a side, sectional view of the airplane wing configuration taken along the line I-I in FIG. 1 wherein the upper wing and the lower wing are in an aircraft cruise orientation;

FIG. 6 is a side, sectional view of the airplane wing configuration taken along the line I-I in FIG. 1 wherein the upper wing and the lower wing are in an aircraft approach (descent) orientation;

FIG. 7 is a side, sectional view of the airplane wing configuration taken along the line I-I in FIG. 1 wherein the upper wing and the lower wing are in an aircraft final approach orientation;

FIG. 8 is a side, sectional view of the airplane wing configuration taken along the line I-I in FIG. 1 wherein the upper wing and the lower wing are in an alternate aircraft final approach (touchdown) orientation;

FIG. 9 is a side, sectional view of the airplane wing configuration taken along the line I-I in FIG. 1 wherein the upper wing and the lower wing are in an aircraft runway braking orientation immediately after touchdown;

FIG. 10 is a side, sectional view of the airplane wing configuration taken along the line I-I in FIG. 1 wherein the upper wing and the lower wing are in an aircraft runway braking orientation after appreciable slowdown of the airplane;

FIG. 11 is a perspective view of an airplane including another embodiment of an airplane wing configuration including an upper wing and a lower wing in accordance with the present invention;

FIG. 12 is a front view of the airplane of FIG. 11;

FIG. 13 is a plan view of the airplane of FIG. 11;

FIG. 14A is a side, sectional view of the airplane taken along the line II-II in FIG. 13 wherein the upper wing and the lower wing are in an aircraft cruise orientation;

FIG. 14B is a side, sectional view of the airplane taken along the line II-II in FIG. 13 wherein the upper wing and the lower wing are in an aircraft approach (descent) orientation;

FIG. 14C is a side, sectional view of the airplane taken along the line II-II in FIG. 13 wherein the upper wing and the lower wing are in an aircraft final approach orientation;

FIG. 14D is a side, sectional view of the airplane taken along the line II-II in FIG. 13 wherein the upper wing and the lower wing are in an alternate aircraft final approach (touchdown) orientation;

FIG. 14E is a side, sectional view of the airplane taken along the line II-II in FIG. 13 wherein the upper wing and the lower wing are in an aircraft runway braking orientation after touchdown of the aircraft;

FIG. 15A is a side, sectional view of an airplane similar to the FIG. 14A wherein the airplane's engine faces backwards and wherein the upper wing and the lower wing are in an aircraft cruise orientation;

FIG. 15B is a side, sectional view of the airplane of FIG. 15A wherein the upper wing and the lower wing are in an aircraft approach (descent) orientation;

FIG. 15C is a side, sectional view of the airplane of FIG. 15A wherein the upper wing and the lower wing are in an aircraft final approach orientation;

FIG. 15D is a side, sectional view of the airplane of FIG. 15A wherein the upper wing and the lower wing are in an alternate aircraft final approach (touchdown) orientation; and

FIG. 15E is a side, sectional view of the airplane of FIG. 15A wherein the upper wing and the lower wing are in an aircraft runway braking orientation after touchdown of the airplane.

### DETAILED DESCRIPTION OF THE INVENTION

The following glossary of definitions of terms used herein is provided for reference.

Angle of attack: The angle between a reference line on an airplane (such as the chord line of the airplane's wing) and the vector representing the relative motion between the airplane and the atmosphere through which it is moving.
Angle of incidence: The angle between the chord line of a wing and the longitudinal axis of the airplane fuselage.
Aspect ratio: Generally the ratio of the length of a wing to the width (chord) of the wing. A high aspect ratio refers to a long and slender wing.
Coanda effect: The tendency of a fluid jet to be attracted to a nearby surface and remains attached even when the surface curves away from the initial jet direction.
Chord: A line joining the trailing edge of a wing to the center of curvature of the leading edge of a cross-section of the wing.
Chord length: The distance between the trailing edge and the point on the leading edge where the chord intersects the leading edge.
Lift: Component of aerodynamic force that is perpendicular to the oncoming flow direction.
Pitch: Angle of rotation about the pitch axis (transverse horizontal axis) of an airplane giving an up-down movement of the nose of an aircraft, which is related to the angle of attack.
Sweep: An angle from the root of a wing to the tip that is forward or backward relative to the fuselage of the airplane.

Referring now to the drawings in detail, numeral 110 generally indicates an airplane having an airplane wing configuration in accordance with the present invention. The present airplane wing is a dual wing configuration including a rotating lower wing. The airplane wing configuration provides for substantially reduced landing speeds, making air travel safer, and thus for the use of shorter runways. The configuration greatly expands the airspeed envelope in which an airplane equipped with the present wing configuration is able to operate over previous wing configurations, and still allows the aircraft to maintain acceptable/comparable cruise efficiency and general fuel efficiency during normal operations.

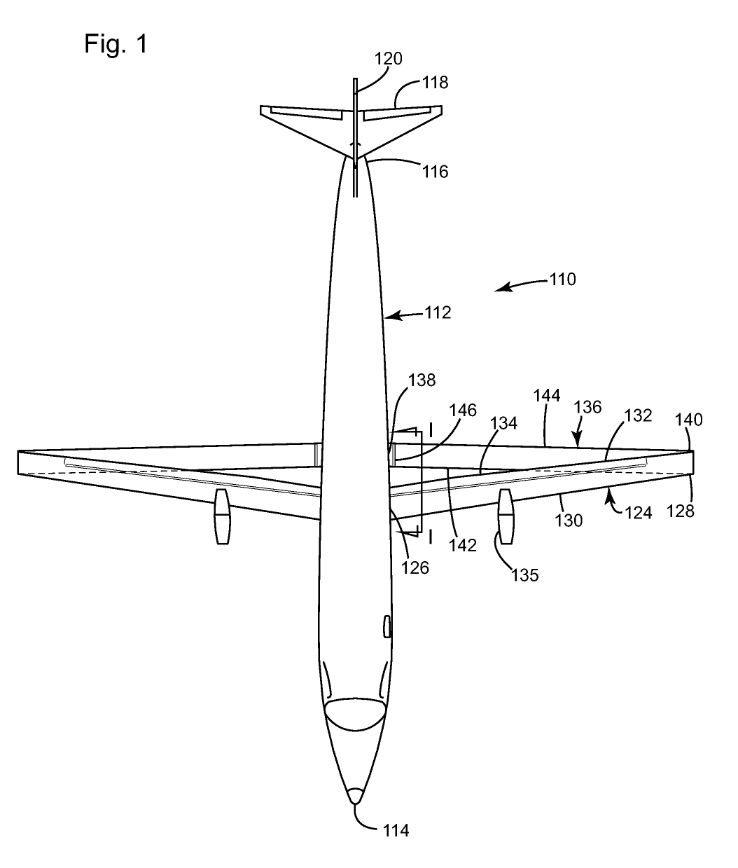

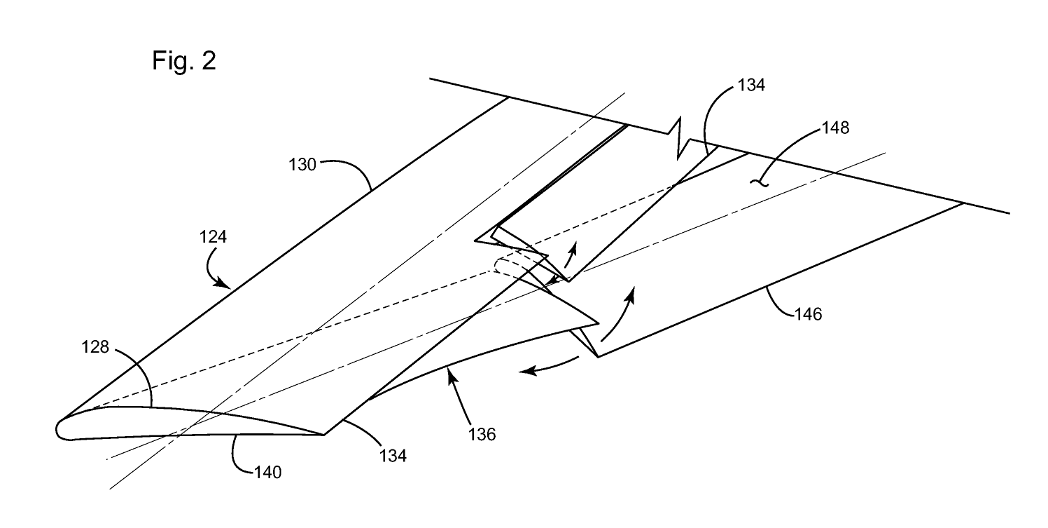

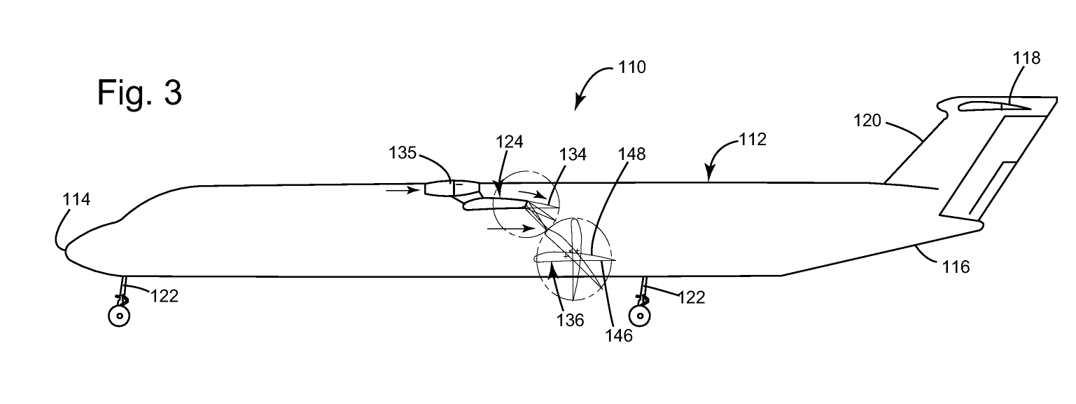

As shown in FIGS. 1 through 3, the airplane 110 generally includes a fuselage 112 having a nose end 114 and a tail end 116. A longitudinal axis (roll axis) of the fuselage 112 extends through the nose end 114 and tail end 116. The fuselage 112 is the aerodynamic body of the airplane and generally houses the cockpit, the passenger space, and the cargo space of the airplane. The cockpit is disposed at the nose end 114 of the fuselage 112, while a horizontal stabilizer 118 (tail plane) and vertical stabilizer 120 (fin) are connected to the tail end 116 of the fuselage 112. The horizontal stabilizer 118 may include an elevator, and the vertical stabilizer 120 may include a rudder. Retractable landing gear 122 are disposed at the bottom of the fuselage 112 and are housed within the underside of the fuselage when in a retracted position. The rear retractable landing gear may alternately be housed in a non-rotating section of a wing of the airplane (such as the lower wing described below) which extends out from the fuselage 112.

A first wing 124 having a wing root 126 fastened to the fuselage 112 and an opposite wing tip 128 extends outwardly from a side of the fuselage. The first wing 124 also has a leading edge 130 and an opposite trailing edge 132. At least one adjustable (pivotable and/or extendable/retractable) wing flap 134 is disposed at and/or extends from the trailing edge 132 of the first wing 124. The first wing 124 may have a high aspect ratio wherein the wing is much longer from root 126 to tip 128 than the average distance from the leading edge 130 to the trailing edge 132. The first wing also may have a generally constant chord and may be swept back. However, in other embodiments in which the first wing is swept back, the first wing may have a tapered chord such that the first wing is wider near the root 126 than at the tip 128, and the trailing edge 132 of the first wing may be nearly perpendicular to the fuselage 112. An engine 135 such as a jet engine or similar is connected to an upper surface of the first wing 124 and is positioned above the first wing.

A second wing 136 having a wing root 138 and an opposite wing tip 140 is also connected to and extends outwardly from the same side of the fuselage 112 as the first wing 124. The first wing 124 is positioned above and forward of the second wing 136, i.e. the second wing is below and behind the first wing. Also, in this embodiment, the wing tip 128 of the first wing 124 is joined to the wing tip 140 of the second wing 136 such that the wings and the fuselage generally form a triangle. In this configuration, each wing provides support for the other wing both horizontally and vertically in much the same way that traditional wing strut provides support. The second wing 136 has a leading edge 142 and a trailing edge 144. An adjustable leading edge slat (not shown) may be disposed at and/or extend from the leading edge 142 of the second wing 136. The second wing 136 may have a high aspect ratio wherein the wing is much longer from root 138 to tip 140 than the average distance from the leading edge 142 to the trailing edge 144, the second wing may have a generally constant chord, and the second wing may be swept forward. The second wing 136 also includes a rotatable portion 146 (such as by pivoting about its axis or generally turning relative to its longitudinal axis) that allows the second wing to change its angle of incidence, and thus its angle of attack, independent of the disposition of the first wing 124. The rotatable portion 146 runs from the leading edge 142 to the trailing edge 114 and may begin at or near the wing root 138 and extend outwardly to a location on the wing span that is near to the wing tip 140, which is fixedly connected to the tip 128 of the first wing 124. It should be understood that the rotatable portion of the second wing may be all or nearly the entire second wing, or that the rotatable portion may be less than the entire second wing. During flight, the rotatable portion 146 may be rotatable through a range of approximately 45 degrees or more to change the angle of incidence of the second wing 136 (and thus the angle of attack of the second wing), and may even be rotatable up to 140 degrees or more after touchdown of the airplane. Although not shown in the drawings, the wing root 138 of the second wing 136 may be engaged with a sloped track on the airplane fuselage 112 (where the forward part of the track slopes up or the rearward part of the track slopes downward), thereby allowing the rotatable portion 146 of the second wing to move forward and backward along the sloped track to change the angle of incidence of the second wing. This may be an advantageous method of rotating the wing where the front wing is swept back. A worm gear or similar may move the rotatable portion 146 of the second wing 136 forward and backward along the track. However, it should be understood that the rotatable portion 146 may be rotated/pivoted by other mechanical arrangements.

The first wing 124 is operable, by adjustment (pivoting and/or extending/retracting) of the at least one wing flap 134, to direct airflow over an upper surface 148 of the second wing 136 enabling the second wing to radically change its angle of attack and still have the airflow attached to its upper surface 148, whereby the first and second wings are capable of generating greater lift than a sum of their individual lifts. Thus, the wing flap(s) 134 of the upper first wing 124 operates in conjunction with the lower second pivoting wing 136 to channel air over the top of the second wing, causing the airflow to remain attached to the second wing even at very high angles of attack of the second wing, preventing the wing from stalling and generating much more lift than is traditionally obtainable at lower air speeds.

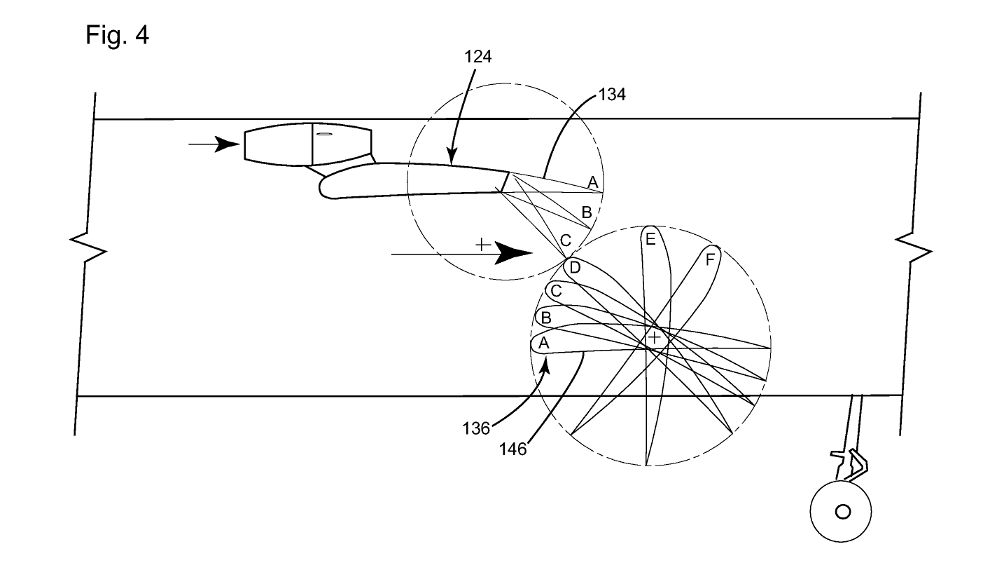

FIG. 4 shows several of the possible orientations of the wing flap 134 on the first wing 124 and the second wing 136, as well as the direction of airflow (arrows). The positions of the upper wing flap 134 are labeled A, B, and C and degrees of rotation of the rotatable portion 146 of the lower second wing 136 are labeled A, B, C, D, E, and F. Some of the various orientations of the wing flap in conjunction with the second wing include an aircraft cruise orientation, an aircraft approach (descent) orientation, an aircraft final approach orientation, an alternate aircraft final approach (touchdown) orientation, an aircraft runway braking orientation immediately after touchdown, and an aircraft runway braking orientation after appreciable slowdown of the airplane.

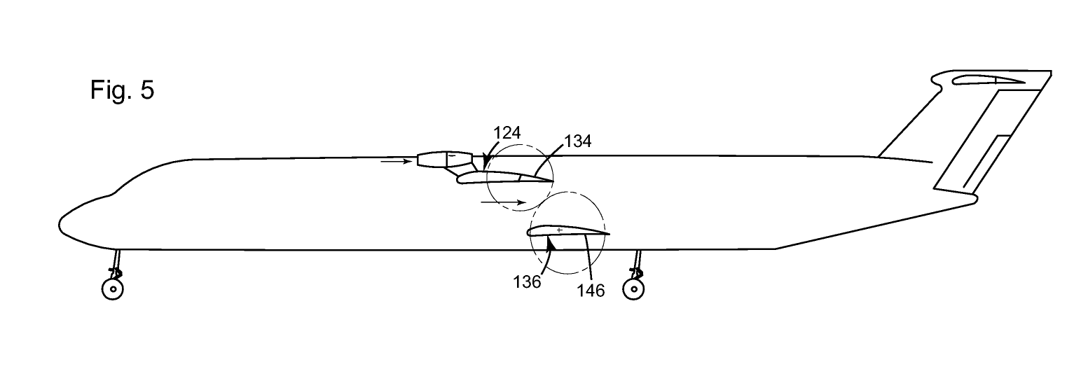

FIG. 5 illustrates the aircraft cruise flight wing orientation in which both the first and second wings 124, 136 possess the same angle of attack and the upper first wing has its flap(s) 134 retracted. While the airplane is in normal flight (such as at cruise altitude), the upper wing flap(s) 134 is in the A position (as shown in FIG. 4) and the rotatable portion 146 of the lower second wing 136 is in the A position with both wings therefore possessing the same angle of attack. Depending on the desired application of the particular aircraft, this configuration and orientation allows for longer wings with higher aspect ratios or for wings of more traditional aspect rations which are shorter than are currently used on commercial jet aircraft.

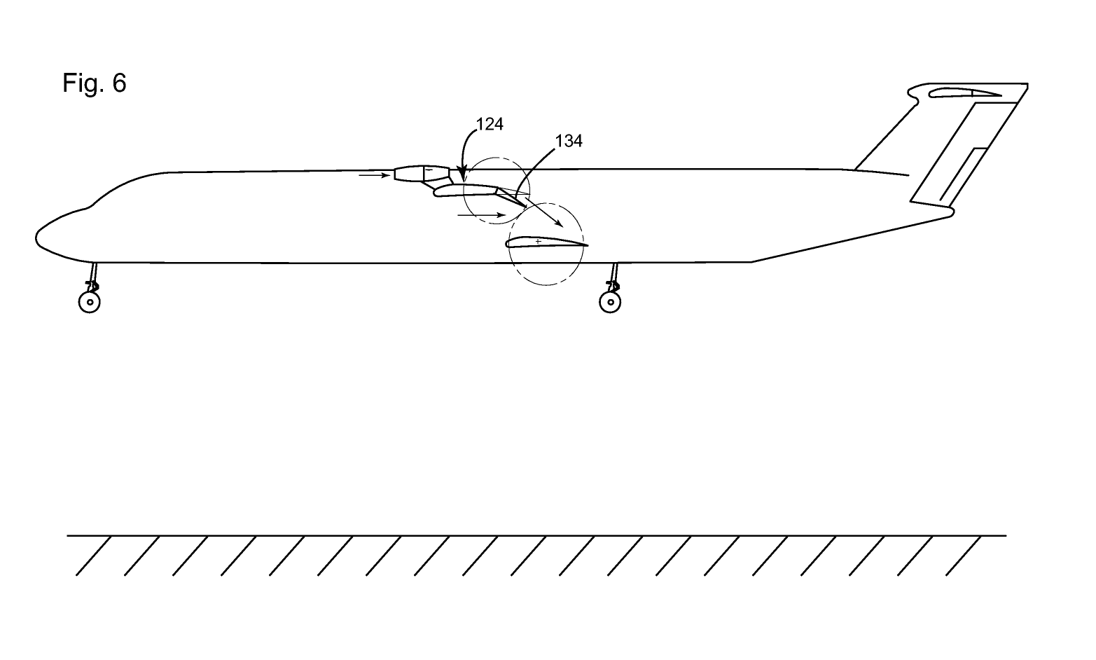

FIG. 6 illustrates the aircraft approach (descent from altitude) orientation as the airplane is descending and coming into the vicinity of an airfield (airport). In this orientation, the upper first wing 124 has its wing flap(s) 134 deployed to the B position (as shown in FIG. 4).

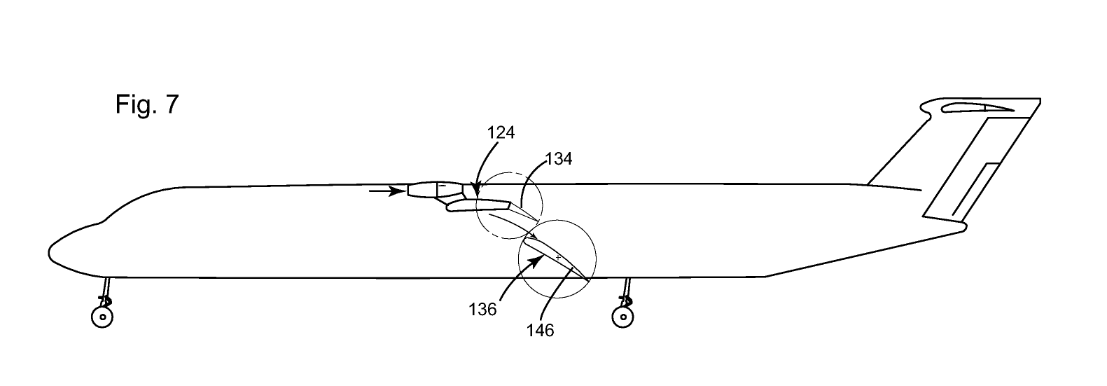

When the airplane approaches the airfield for landing (e.g., within 10 miles of the airfield) and before turning for the final approach, the lower second wing's angle of attack is increased resulting in significantly greater lift at lower air speeds allowing for lower landing speeds. With this aircraft approach wing orientation, enough drag is produced by the first and second wings 124, 136 so that pilots will typically land with some power still being supplied by the engines. This allows the pilots to keep the airplane's engines spooled up sufficiently to make full emergency power available in less than half the time than is traditionally possible. Referring to FIG. 7, as the airplane nears the airfield the upper wing flap(s) 134 is in the B position and the rotatable portion 146 of the lower second wing 136 is rotated to the B or C position (as shown in FIG. 4). Lowering the wing flap(s) 134 accelerates the air over the second wing 136, providing more lift on the second wing as well as providing increased lift on the upper first wing 124. This orientation can also be used for performance takeoffs on short fields. Short field takeoffs are accomplished by accelerating the airplane with the upper wing flap(s) 134 partially extended and the lower second wing 136 possessing the same angle of attack as the first wing 124. After the engines reach full power and the airplane has reached takeoff speed, the angle of attack of the rotatable portion 146 of the second wing 136 is quickly increased enabling the airplane to maintain a steep angle of ascent and clear obstacles while still traveling at a relatively slow airspeed.

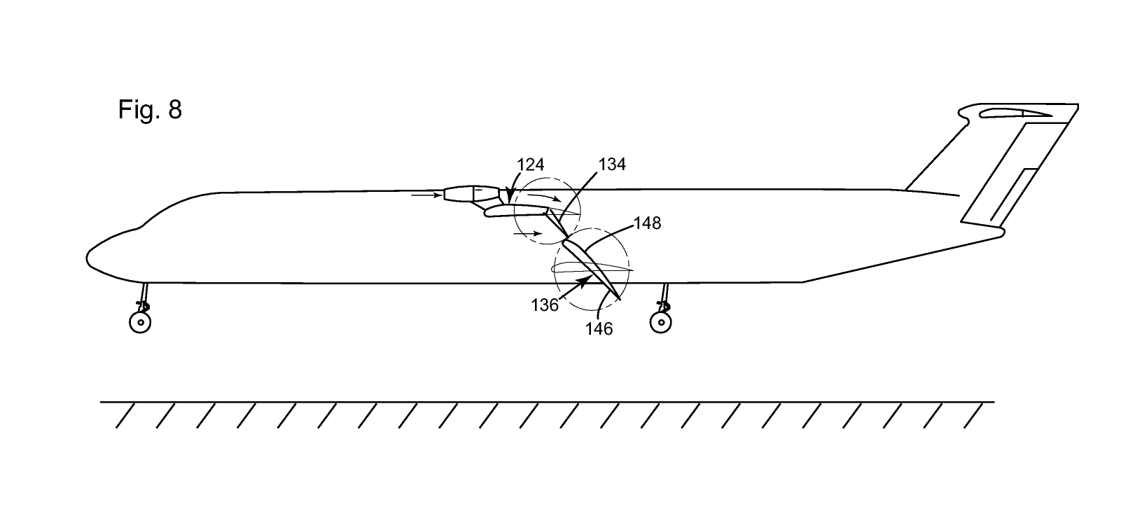

As the airplane has turned final and is descending to land (touchdown), the upper wing flap(s) 134 is maintained in the B position and the rotatable portion 146 of the lower second wing 136 is rotated to the D position (as shown in FIG. 4). On or just before touchdown, the wings are positioned in an alternative final approach orientation illustrated in FIG. 8 in which the wing flap(s) 134 of the upper first wing 124 is lowered to the C position with the rotatable portion 146 of the lower second wing 136 is rotated to the D position (as shown in FIG. 4). In this orientation, the airflow over the upper surface 148 of the second wing 136 is reduced, facilitating the wing stalling and increasing drag. With the engine still producing some thrust and the wings in the alternative final approach (landing) orientation (upper wing flap(s) down and the lower wing rotated to a high angle of attack), air is accelerated across the upper surface 148 of the lower second wing 136 providing greatly increased lift at lower airspeeds. This lift is directed both upward and aft. The pilot maintains a portion of the engine's power to overcome the intense drag of the rotated second wing 136 for a slow, stable landing. Maintaining a portion of the engine's power until touchdown allows emergency power to be quickly available in case of an emergency abort of the landing.

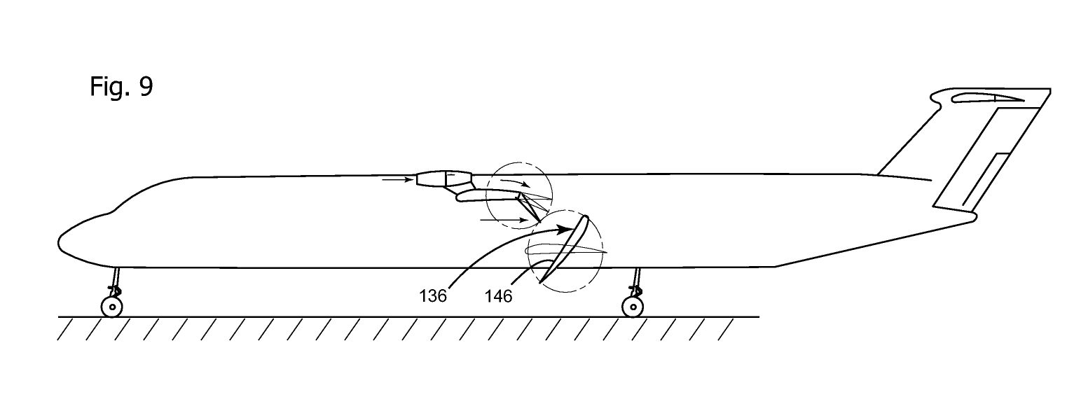

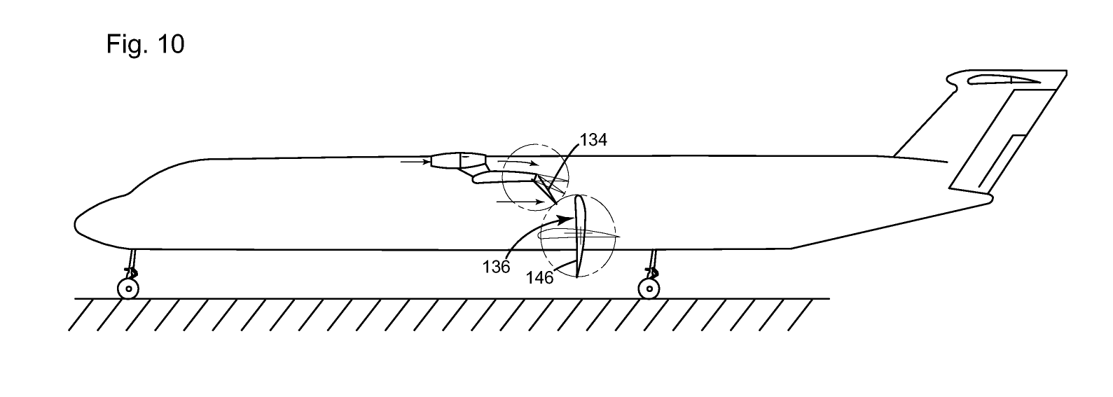

After touchdown, the rotatable portion 146 of the second wing 136 rotates even further into an aircraft runway braking orientation, providing an air brake which is of immense size and effectiveness compared to what is attainable with traditional flaps. As illustrated in FIG. 9, immediately after touchdown as the airplane slows on the runway, the rotatable portion 146 of the lower second wing 136 is rotated to the F position (as shown in FIG. 4). This orientation pushes the airplane down onto the runway, providing for better braking and preventing wind gusts from lifting the airplane back into the air. This extreme pivoting of the second wing holds the airplane on the ground in adverse wind conditions preventing it from becoming airborne again in the wind gusts which are frequently associated with thunderstorms and airports located in mountainous areas. It also holds the wheels on the ground allowing the airplane's brakes to work efficiently. This orientation also dramatically slows the airplane down, allowing for safe short-field landings and aborted takeoffs when they otherwise would not be possible. After the airplane has slowed appreciably on the runway, the lower second wing is rotated into the alternative runway braking orientation illustrated in FIG. 10. Specifically, the rotatable portion 146 of the second wing 136 is rotated into the E position (as shown in FIG. 4). After the airplane has slowed to taxi speed, the rotatable portion 146 is rotated back into the A position and the wing flap(s) 134 are pivoted/retracted back into the A position.

The present wing configuration allows for operation out of airports having much shorter runways than is currently possible. Slower landing speeds also reduce tire and brake wear. The wing configuration is particularly useful whenever slow landing or takeoff speeds provide an advantage. There are many situations where slow landing speeds provide greater safety. Slow landing speeds are important in the following conditions: 1) Short runways in mountainous areas; 2) Seaplane operations, particularly if there are any waves; 3) Emergency or crash landings in every venue, especially in water or in mountainous areas; 4) Resuming flight speed after a failed landing; 5) Emergency stops precipitated by runway incursions; 6) Bush pilot/Rough field operations; 7) Adverse weather conditions including poor visibility, icy runways, heavy rain, gusty winds and crosswinds; and 8) Carrier operations.

Further, the lower second wings 136 (on either side of the aircraft) can be designed to be rotated in opposite directions and thus act like a giant aileron for emergency situations where microbursts have pushed one wing toward the ground during landing. Using the lower second wing as a giant aileron or reducing the angle of attack of only one lower wing during flight enables a pilot to quickly avoid a collision where another airplane or a flock of birds suddenly appear in the aircraft's flight path. This capability to maneuver rapidly also could assist military aircraft in avoiding incoming anti-aircraft fire or missiles.

The present wing configuration allows aircraft to respond faster to control inputs at lower air speeds enabling pilots to return the aircraft to a proper flight attitude more quickly when strong winds push aircraft around as they are approaching to land. Also, the wing configuration dramatically reduces impact speeds when aviation accidents do occur, reducing loss of life dramatically and making most aircraft accidents survivable.

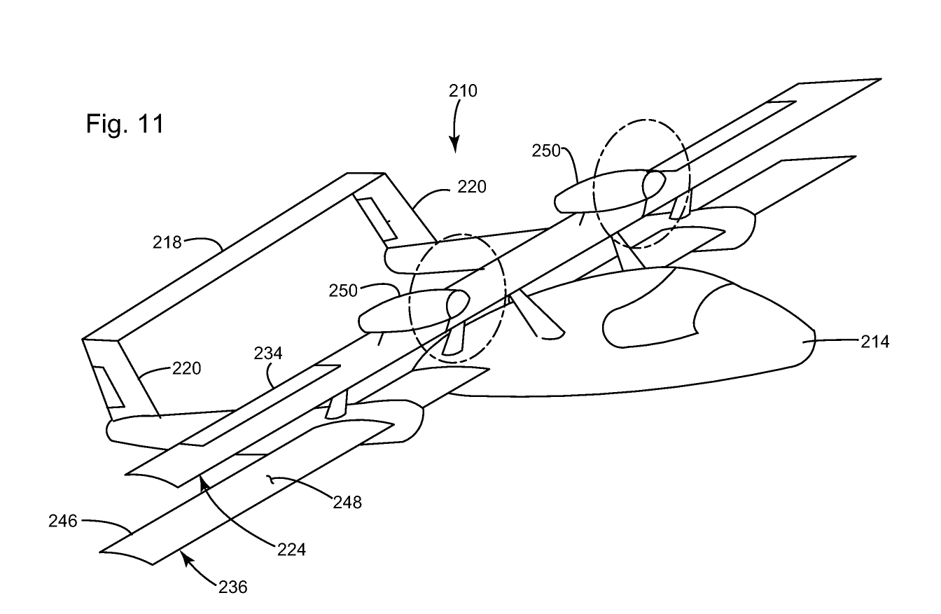

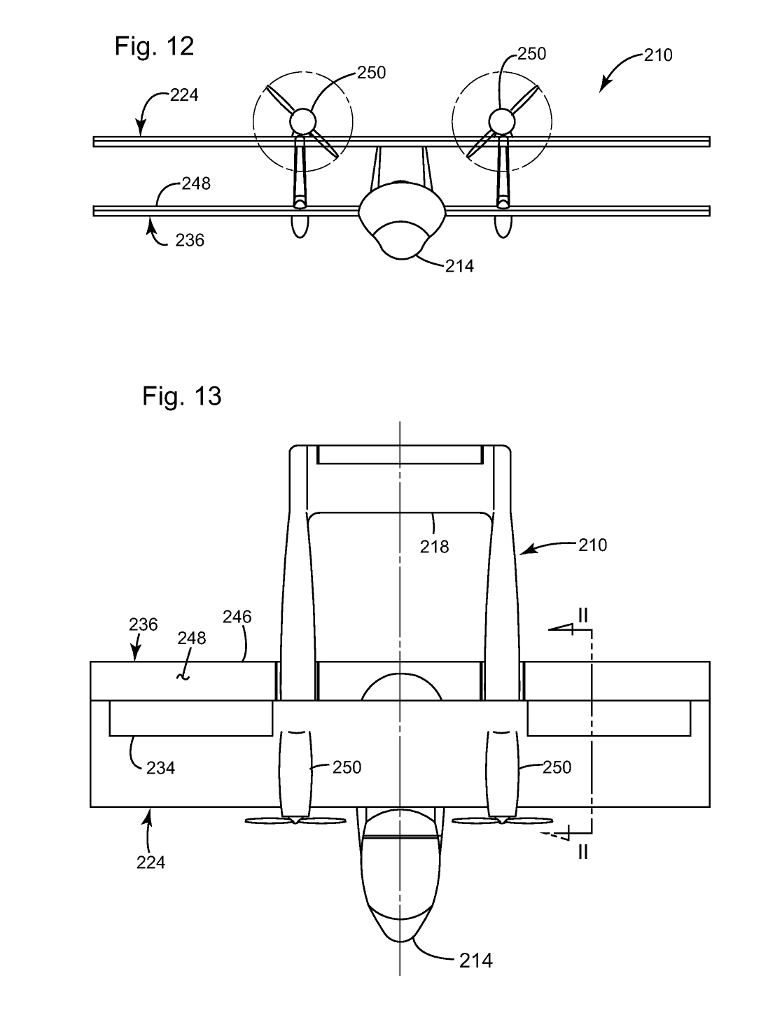

In a second embodiment shown in FIGS. 11 through 13, the upper first wing 224 and the lower second wing 236 of the airplane 210 are arranged in a biplane-like configuration in which the wing tips are not joined. Instead, the first and second wings 224, 236 are joined and braced by vertical struts at a position between the root and tips of the wings. Also, the first and second wings are generally straight (no sweep) and have a generally constant chord. The upper first wing 224 includes at least one wing flap, in this case two wing flaps 234, similar to the wing flap(s) in the first embodiment, and the lower second wing 236 includes a rotatable portion 246 similar to the first embodiment. In this embodiment, the airplane's engines 250 (such as a propeller engine or similar) face forward, with thrust being provided in a direction from front to back of the airplane and air flow being blown over the wings. As described below, the orientation of the engines may be reversed. Also, the airplane 210 according to the second embodiment also includes a large tail end structure to keep the nose end 214 of the airplane from pointing down an excessive amount (excessive pitch) during operation of the upper and lower wings. More specifically, the tail of the airplane 210 includes a pair of spacedly disposed vertical stabilizers 220 that are connected at their upper ends by an elongated horizontal stabilizer 218. Although not shown in the drawings, the airplane also may include two (or more) horizontal stabilizers (tail surfaces) to provide sufficient thrust to counteract downward movement (pitch) of the nose 214 of the airplane 210 during operation of the first and second wings 224, 236. The horizontal stabilizer 218 may include an elevator (or alternatively the entire horizontal stabilizer may rotate), and the vertical stabilizers 220 may each include a rudder.

The operation of the second embodiment is essentially the same as the first embodiment. Specifically, the first wing 224 is operable, by adjustment (pivoting and/or extending/retracting) of the at least one wing flap 234, to direct airflow over an upper surface 248 of the second wing 236 enabling the second wing to radically change its angle of attack and still have the airflow attached to its upper surface 248, whereby the first and second wings are capable of generating greater lift than a sum of their individual lifts. Thus, the wing flap 234 of the upper first wing 224 operates in conjunction with the lower second pivoting wing 236 to channel air over the top of the second wing, causing the airflow to remain attached to the second wing even at very high angles of attack, preventing the wing from stalling and generating much more lift than is traditionally obtainable at lower air speeds.

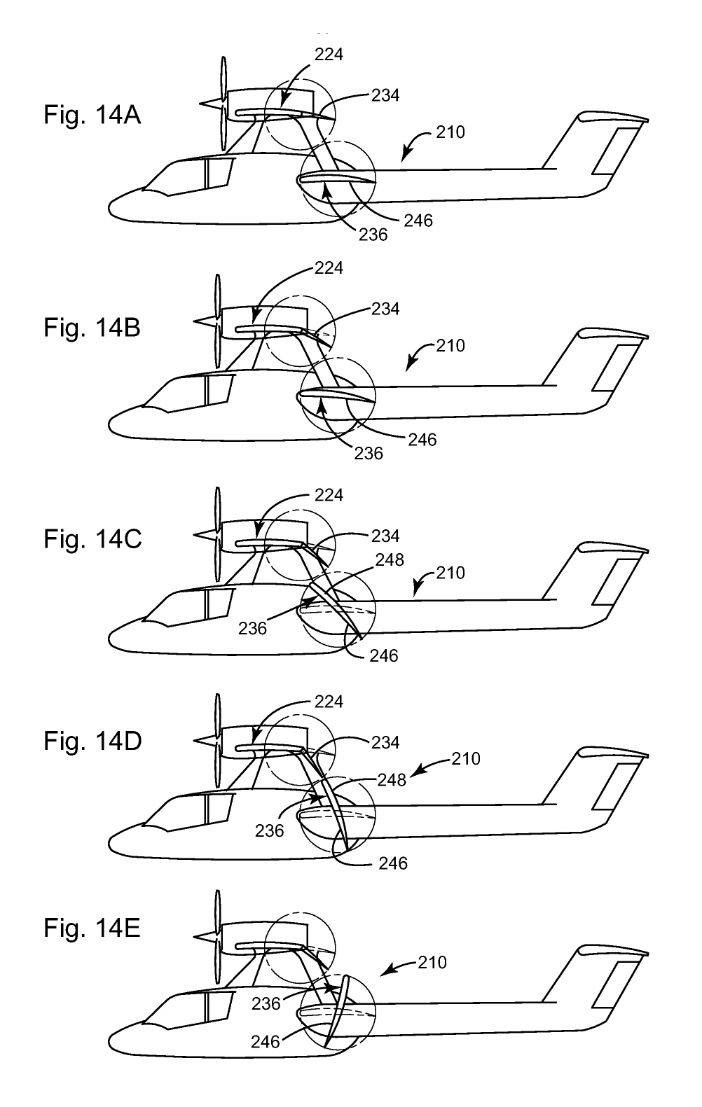

For example, the upper first wing 224 and the lower second wing 236 are operable to be positioned in the following orientations. As shown in FIG. 14A, in an aircraft cruise flight orientation used when the airplane 210 is at a cruise altitude, the flap 234 on the upper first wing 224 are up (and/or retracted) and both the first wing and the lower second wing 236 possess the same angle of attack. The rotatable portion 246 of the second wing 236 is in a neutral, non-pivoted position.

As shown in FIG. 14B, in an aircraft approach (descent) orientation used when the airplane 210 is approaching an airport, the flap 234 on the upper first wing 224 is lowered (partially pivoted/extended) and the rotatable portion 246 of the lower second wing 236 may be partially pivoted to increase the angle of attack on the lower wing. Lowering the flap 234 on the first wing 224 increases the lift on the first wing in the normal way that a flap increases lift and drag. Lowering the upper wing flap also increases the velocity of the air passing over the lower second wing 236 as it compresses and accelerates the air over the second wing. Increasing the angle of attack on the second wing also results in substantially higher lift being produced by the second wing. For a moderate increase in drag, lift is greatly increased allowing for slower approach speeds.

As shown in FIG. 14C, in an aircraft final approach orientation used when the airplane 210 turns final and is descending to land, the rotatable portion 246 of the lower second wing 236 is pivoted further. The flap 234 on the upper first wing 224 channels the airflow over the upper surface 248 of the lower second wing 236, keeping the airflow attached and preventing the second wing from stalling despite it possessing a higher angle of attack than that which would normally allow the airflow to remain attached. Substantial lift is generated from the Coanda effect acting on the lower second wing 236. Much of this lift is 90 degrees from the rotated lower second wing 236 allowing for very steep descents and touchdowns at very slow airspeeds.

As shown in FIG. 14D, in an alternative aircraft final approach (touchdown) orientation, the flap 234 on the upper first wing 224 is fully lowered/extended and the rotatable portion 246 of the lower second wing 236 is rotated to a position at which the trailing edge 232 of the upper wing flap is in line with the leading edge 242 of the lower wing. This orientation may be used, for example, in emergency situations or when wind conditions are more severe and/or when the runway is shorter. The airflow over the upper surface 248 of the lower second wing 236 is cut off, reducing lift and increasing drag for a steeper approach.

As shown in FIG. 14E, in an aircraft runway braking (after touchdown) orientation used in high wind conditions and on short runways, the angle of attack of the lower second wing 236 is reversed by rotating the rotatable portion 246 past a vertical position so that drag is maximized and the forward motion of the airplane 210 forces the airplane onto the ground, increasing the stopping ability of the brakes.

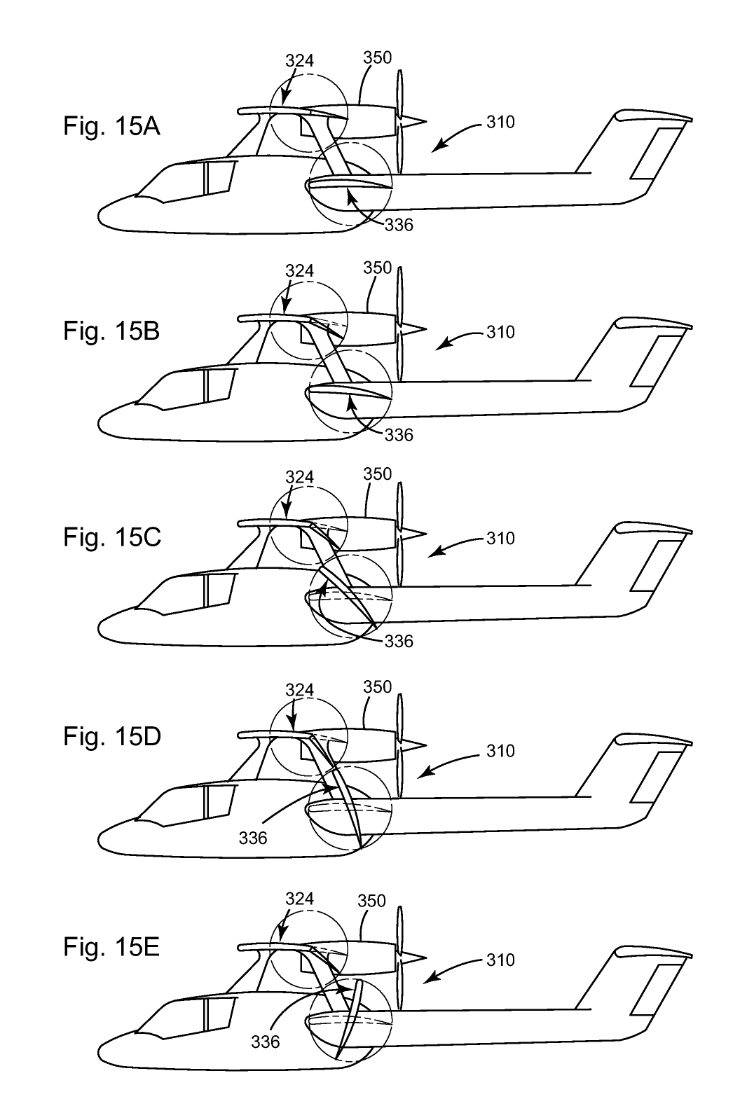

In an alternative arrangement shown in FIGS. 15A-E, the first and second wings 324, 336 have the same orientations as described in FIGS. 14A-E above. However, in this arrangement, the engine 350 of the airplane 310 faces the tail end of the airplane 310 such that air is sucked across the wings rather than blown.

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.

What is claimed is:

1. An airplane wing configuration comprising:
a first wing positioned above and forward of a second wing on an airplane fuselage;
the first wing being operable to direct airflow over an upper surface of the second wing, whereby the first and second wings are capable of generating greater lift than a sum of their individual lifts.

2. The airplane wing configuration of claim 1, wherein the first wing includes an adjustable wing flap that redirects airflow over the upper surface of the second wing.

3. The airplane wing configuration of claim 1, wherein the second wing includes a rotatable portion that pivots to vary the angle of attack of the second wing independent of the first wing.

4. An airplane wing configuration comprising:
a first wing including a wing root fastened to an airplane fuselage and an opposite wing tip; and
a second wing including a wing root fastened to the airplane fuselage and an opposite wing tip, the second wing being disposed on a same side of the airplane fuselage as the first wing;
the first wing being positioned above and forward of the second wing;
the wing tip of the first wing being joined to the wing tip of the second wing;
the second wing being operable to change its angle of attack independent of the first wing.

5. The airplane wing configuration of claim 4, wherein the second wing includes a rotatable portion between the wing root and the wing tip.

6. The airplane wing configuration of claim 5, wherein the rotatable portion of the second wing is rotatable in a range of at least 140 degrees.

7. The airplane wing configuration of claim 5, wherein the rotatable portion of the second wing is rotatable in a range of at least 45 degrees.

8. The airplane wing configuration of claim 4, wherein the first wing is swept back.

9. The airplane wing configuration of claim 4, wherein the first wing includes a wing flap, the wing flap redirecting airflow over an upper surface of the second wing.

10. The airplane wing configuration of claim 4, wherein the first wing has a high aspect ratio.

11. The airplane wing configuration of claim 4, wherein the second wing has a high aspect ratio.

12. An airplane wing configuration comprising:
a first wing fastened to an airplane fuselage; and
a second wing including a wing root fastened to the airplane fuselage and an opposite wing tip;
the first wing being positioned above and forward of the second wing;
the second wing being operable to change its angle of attack independent of the first wing.

13. The airplane wing configuration of claim 12, wherein the first wing includes a wing flap, the wing flap redirecting airflow over an upper surface of the second wing.

14. The airplane wing configuration of claim 12, wherein the second wing includes a rotatable portion between the wing root and the wing tip.

15. An airplane equipped with the airplane wing configuration of claim 1.

16. An airplane equipped with the airplane wing configuration of claim 4.

17. An airplane equipped with the airplane wing configuration of claim 12.

18. Method of configuring two airplane wings to act in concert with each other, the method comprising the steps of:
fastening a first wing to an airplane fuselage, the first wing including a wing flap disposed at a trailing edge thereof;
fastening a second wing to the airplane fuselage, the first wing being positioned above and forward of the second wing, and the second wing being operable to change its angle of attack independent of the first wing;
adjusting the wing flap of the first wing to direct airflow from the first wing over an upper surface of the second wing; and
rotating at least a portion of the second wing to increase the angle of attack of the second wing.

19. The method of claim 18, including the steps of:
adjusting the wing flap of the first wing into a retracted position; and
adjusting the angle of attack of the second wing so that it is generally equal to the angle of attack of the first wing;
whereby the first and second wings are disposed in a cruise flight orientation.

20. The method of claim 19, including the steps of:
partially lowering the wing flap of the first wing while maintaining the angle of attack of the second wing;
whereby the first and second wings are disposed in an altitude decent orientation.

21. The method of claim 18, including the steps of:
partially lowering the wing flap of the first wing; and
adjusting the disposition of the second wing by rotating the portion of the second wing to increase the angle of attack of the second wing;
whereby the first and second wings are disposed in a landing approach orientation.

22. The method of claim 21, including the step of:
further increasing the angle of attack of the second wing by rotating the portion of the second wing;
whereby the first and second wings are disposed in a final approach orientation.

23. The method of claim 22, including the steps of:
fully lowering the wing flap of the first wing; and
adjusting the disposition of the second wing by rotating the portion of the second wing so that the second wing is generally parallel with the wing flap of the first wing;
whereby the first and second wings are disposed in a takeoff or touchdown orientation.

24. The method of claim 23, including the step of:
adjusting the disposition of the second wing by rotating the portion of the second wing so that the portion of the second wing is oriented more than 90 degrees from horizontal;
whereby the first and second wings are disposed in an air brake orientation.

25. The method of claim 24, including the step of:
adjusting the disposition of the second wing by rotating the portion of the second wing so that the portion of the second wing is in a generally vertical orientation.
